(19) United States
(12) Patent Application Publication
(10) Pub. No.: US 2019/0050388 A1
(43) Pub. Date: Feb. 14, 2019

(54) METHOD AND DEVICE FOR DETECTING STYLE WITHIN ONE OR MORE SYMBOL SEQUENCES

(71) Applicant: Orphanalytics SA, Verbier (CH)

(72) Inventors: Myriam EUGSTER, Vevey (CH); Augustin Camille KASSER, Lausanne (CH); Stefan CODRESCU, Ecublens (CH); Antoine JOVER, Burgistein (CH); Alexandre-Pierre COTTY, Sion (CH); Sylvain MEYLAN, Rio de Janeiro (CH); Agnés Marie Thérèse DAYER, Sion (CH); Aurélien BUSSARD, Gland (CH); Valentin ROTEN, Arbaz (CH); Alain FAVRE, Nods (CH); Luc-Olivier POCHON, Cormondrèche (CH); Claire ROTEN, Vevey (CH); Jean-Luc BUHLMANN, Saint-Julien-en-Genevois (FR); Guy GENILLOUD, Neyruz (CH); Léonard André Henri STUDER, Villeneuve (CH); Claude-Alain ROTEN, Vevey (CH)

(21) Appl. No.: 16/078,597

(22) PCT Filed: Feb. 22, 2016
(86) PCT No.: PCT/IB2016/050937

§ 371 Date: Aug. 21, 2018

(51) Int. Cl. G06F 17/27

(52) U.S. Cl. CPC G06F 17/274; G10H 2210/031; G06F 17/278

(57) ABSTRACT

The invention relates to a method making it possible to detect style breaks within one or more symbol sequences (20). Said method includes the following steps: automatically slicing at least one so-called “symbol sequence” (2) into a plurality of windows (20A, 20B, . . . ), at least two windows partially overlapping; determining a plurality of style parameters in some or all of said windows, at least one so-called “style parameter” corresponding to the number of occurrences of at least two predetermined N-grams in the window, each so-called “N-gram” being made up of a series of N predetermined symbols, N being less than or equal to 5; calculating, using a processor, a stylometric distance between at least one so-called “window to be authenticated” and one or more reference windows, the stylometric distance between two windows or window groups, depending on a plurality of style parameters; identifying first windows for which the stylometric distance relative to the reference window(s) is greater than a predetermined threshold.

### TECHNICAL FIELD

The present invention relates to detecting the breakage of style within a document or other sequence of symbols, in order to detect for example the use of plagiarized texts (taken without reference to the author) or of all or parts of the text produced by a mercenary author working anonymously for the candidate.

### STATE OF THE ART

Knowledge of the true author of a text is often important for reasons of copyright, document authentication, or forensics, for example to identify the author of an anonymous letter, a suicide note, to certify the author of an e-mail, of a publication, etc.

Various solutions have therefore been proposed to authenticate or identify the author of a document.

WO2008/036059 discloses an author identification method based on the linguistic analysis of text units. The linguistic analysis is based for example on the lexical analysis, including the frequency of appearances of certain words or prepositions, as well as the stylometric analysis, including punctuation, the average length of the words, the number of short words, or the average length of the paragraphs. A graphemic analysis including a count of the letters and of the punctuation signs, and a syntactic analysis including the counting of the nouns, of the verbs etc., are also suggested. The analysis is performed at the level of each sentence or of the entire document. It is therefore intended for authenticating complete documents.

Besides the problem of author attribution, the question of plagiarism or literary negriat, designated by ghostwriting in this document, is also known. Ghostwriter designates the anonymous mercenary author historically called literary negro. Signatory designates the person who presents under his name all or part of a sequence of symbols (for example a document, a text, a musical score, . . . ).

Literary plagiarism, i.e. the unauthorized taking over by an author of a text extract by another author, is probably almost as old as literary creation itself. The possibilities of quickly retrieving texts on many subjects thanks to search engines, and effortlessly copying them into a word processing program, have however accentuated the intensity of this problem of plagiarism.

In the same way, ghostwriting, i.e. the process of appropriating a text by another anonymous author by signing it, has been practiced since time immemorial. The Web is currently promoting ghostwriting by anonymously linking writers suffering from writers' block to ghostwriters.

Plagiarism is particularly problematic in schools and universities when a student copies portions of another author's text, such as sentences, paragraphs or even chapters, to obtain undeserved credits or to save work. It is unfortunately also frequent for example in journalism, creative writing, scientific papers or computer programming. Ghostwriting is also prevalent in schools where some students do not hesitate to submit essays, memoirs or reports written entirely by a third party, with or without their consent. This process is found in many other areas of text creation.

Plagiarism and ghostwriting pose problems of copyright infringement, and forgery and falsification of documents in terms of academic certifications. They often result in financially or morally rewarding the dishonest author in an undeserved way. The dishonest signatory can therefore be a cheat during his studies, be designated as the author of a publication to which he has not contributed, or even be considered the inventor of a patent based on the invention announcement of a third party.

The detection of plagiarism and ghostwriting is therefore of considerable importance. Traditional author verification methods are poorly suited to the detection of plagiarized or ghostwritten texts that can be fragments of a larger text.

A common plagiarism detection solution is to check whether a suspicious text, or a suspicious portion of a text, can be found in a database of previous works, for example on the Internet or in a collection of student work. Software can automate this search by slicing (cutting) a text to check in predefined fragments that will be checked one by one. This process is tedious in the case of a long text. This method does not detect the plagiarism of a text missing from the verification database, the translation of a plagiarized text or its rewriting, etc. These methods of detecting plagiarism also produce many false positives (detection of plagiarism in a text not using plagiarized fragments) when a frequent or commonplace sentence is used; for example, the sentence “William Shakespeare lived in Stratford-upon-Avon” is likely to be found in countless books without there being any question of plagiarism. The manual verification of these false positives requires considerable time and makes this type of detection unreliable with the authors examined and the evaluators concerned.

If a student uses the unpublished work of an accomplice to write all or part of his work, this ghostwritten fragment is undetectable to the plagiarism detection methods described in the previous paragraph. One solution consists in analyzing the style of a text or a portion of text to see if it matches the style of the alleged author. This is the approach of the teacher who, for example, suspects a plagiarism if he discovers a passage in Alexandrine verse in the writing of a young student. The human brain is sensitive to significant changes in literary style. It can subjectively detect style breaks in a text. This critical process requires a careful reading of the text by a human proofreader. It is therefore unsuited for verifying text plagiarism of the same type of writing or when an evaluator has to authenticate a significant number of documents.

Java Graphical Authorship Attribution Program (JGAAP) is a modular Java program which, as of the filing date of the present invention, can be downloaded from the website http: //evllabs.eom/jgaap/w/index.php/Main_Page. In its version 6.0, it allows the stylometric and textometric analysis of text for purposes of categorization and author attribution. However, it does not allow the detection of plagiarized passages within a longer document. For its use, this software requires an operator trained in author attribution.

### BRIEF SUMMARY OF THE INVENTION

There is therefore a need for a method for detecting plagiarism and/or ghostwriting which can be automated and executed for example by means of a machine or a computer system.

There is also a need for a method for detecting plagiarism and/or ghostwriting which provides reproducible results and which is less subjective than the methods of the prior art.

According to one aspect of the invention, these objects are achieved in particular by means of parameters characterizing the style of a window in the document. The choice of these style parameters and/or their value can be determined automatically. They advantageously make it possible to characterize the style of a window automatically and objectively.

In one example, the style parameters may include, for example, the number of occurrences of one or more predefined N-grams in each portion of text. An N-gram is a sequence of N symbols (e.g. letters or other typeface characters), N being an integer preferably between 1 and 5. The symbols can be consecutive; for example, different style parameters may correspond to the number of occurrence of unigrams (1-grams) <a>, <b>, <c>, . . . <A>, <B>, <C>, . . . or bigrams (2-grams) <aa>, <ab>, <ac>, . . . or trigrams (3-grams) <aaa>, <aab>, <aac> etc.

N-grams may also consist of non-consecutive symbols, for example symbols separated by any number of arbitrary symbols #: <a # a>, <a # b>, etc. according to stylometric analysis rules: <a # a>, <a # b>, etc. For example, these N-grams can specify the beginning and end of a word, so that <a # a> would represent the word “abracadabra”.

N-grams may also consist of non-consecutive symbols, for example symbols separated by a fixed number of arbitrary symbols *: <a * a>, <a * b>, etc. according to stylometric analysis rules: <a * a>, <a * b>, etc. For example, <a * a>would represent the word “ara” but not the word “abracadabra”.

The style of each portion of text is thus determined from very simple language elements, a little as if one determined the Gothic style of a cathedral by studying the stone that is used instead of being interested in the overall impression.

According to one aspect, the invention arises from the observation that these language bricks are highly personal and difficult to manipulate. The style parameters of each portion of text thus constitute a biometric trace of the author's stylometric signature. It is observed that the style parameters associated with each author depend on his way of thinking, much like the phrasing played by a jazzman is highly personal.

The style parameters of a text naturally depend on the type of text. In French, an author who makes extensive use of the passive form is characterized by a high occurrence of the unigram <é> and the bigrams <ée> and <és>. The use of the imperfect subjunctive tense, little used, is characterized by an unusual frequency of N-gram “asse” for example. A medical text presents a high occurrence of N-grams “ose” or “ite”.

Other N-grams are more personal. Quite unexpectedly, some people consistently use certain letters or bigrams, trigrams, and so on. more often than others—regardless of the type of text, the level of education or the literary style.

We know that some authors prefer short sentences while others like long sentences. Tests performed on a large number of texts by different authors have revealed a use of highly personal punctuation. For example, the number of commas, semicolons, full stops etc. varies greatly from author to author. Again, an explanation related to the rhythms of writing and personal turn of phrases is preferred.

According to an independent aspect of the invention, the method of detecting breaks in style includes detecting sequences or punctuation mark patterns in different symbol windows. For example, the detection of style breaks includes counting the number of occurrences or the average or median distance between two predetermined punctuation marks within said window. These style parameters are particularly suited to author attribution in relatively short symbol sequences.

According to an independent aspect of the invention, the method of detecting breaks in style comprises detecting sequences of word lengths.

According to another aspect of the invention, breaks in style are detected by calculating the stylometric distance between two portions of text, for example between a text to be tested and a reference text, or between two portions of the same text. The stylometric distance depends on the style parameters made on the compared fragments. In one example, the stylometric distance is a Euclidean distance between several style parameters.

According to another independent aspect of the invention, the method comprises a step of slicing a sequence of symbols, for example a document, into windows. The slicing (cutting) is advantageously independent of the content; for example, it is advantageous to slice a text or another sequence of symbols into windows having all, or almost all except for example the first or the last, the same length. This feature makes it possible to perform comparisons with windows of optimal length, that is, not too short to avoid style measurements disturbed by rare events, or too long to allow plagiarism detection of short sequences.

The length of the windows is advantageously greater than 500 symbols. This minimum allows a homogeneous statistical distribution of N-grams in different windows of the same author.

The length of the windows is advantageously less than 10,000 symbols, preferably less than 5,000 symbols. This threshold allows the detection of relatively short plagiarized fragments, for example fragments corresponding to a few paragraphs or a few pages.

To locate short fragments of another writing, windows should preferably overlap. Two windows overlap when they contain portions of text in common. The method then includes determining the stylometric distance between some, or preferably all, of these windows, and reference windows taken from the same text or another text. This feature allows the style of portions of text that begin and end at any location to be detected and compared, without being limited to predetermined locations.

The invention relates to a method for detecting breaks in style within one or more sequences of symbols: texts, phonetic transcriptions, musical scores, or even genetic sequences, and comprising the following steps:

automatically slicing at least one said sequence into a plurality of windows. The division is preferably independent of the content and of the structure in sentences, paragraphs, etc. Preferably, at least two windows overlap;

determining a plurality of style parameters in some or all of said windows, at least one said style parameter corresponding to the number of occurrences of at least two predetermined N-grams in the window, each said N-gram consisting of a sequence N predetermined symbols, N being less than or equal to 5;

calculating by a processor a stylometric distance between at least one window to be authenticated and a reference window or a group of reference windows, the stylometric distance between two windows or groups of windows depending on several style parameters;

identifying windows to authenticate based on their stylometric distance relative to the reference window or group of reference windows.

During identification, the windows to be authenticated close to a reference window or a group of reference windows (for example those whose stylometric distance is less than a threshold) are considered to be from the same author as the author of the reference window or group. The windows to be authenticated that are remote from a reference window or from a group of reference windows (for example those whose stylometric distance is greater than the threshold) are considered to be from another author or from another literary style than the author of the reference window or group.

The method may include a step of grouping windows into groups of windows having near style parameters.

The N-grams to be counted can be chosen according to the object to be identified.

This method makes it possible to determine style parameters associated with different windows sliced in a symbol sequence, and then to measure the stylometric distance between each window to be authenticated and one or more reference windows. A suspicion of plagiarism or ghostwriting is displayed when this distance exceeds a predetermined threshold.

Thanks to the windowing which automatically breaks up the sequence of symbols, this method of looking for style breaks thus makes it possible to determine whether a sequence is the work of a single author or of several authors, or if it is composed of several literary, musical and other genres.

The division into windows can be done according to the content (e.g. chapters, scenes, musical movements).

The division into windows can be independent of the content, without being linked for example to the structure of a sequence in propositions, sentences, staves, paragraphs, or pages . . .

The symbols can be alphanumeric characters. The sequence of symbols is then a text. The method then makes it possible to detect plagiarism or ghostwriting in literary works, training certification transcripts, or computer programs for example.

The symbols can be phonemes, in the case of a phonetic transcription of a text for example. The method then makes it possible to detect plagiarisms or ghostwriting from phonetic transcriptions, plays or speech for example. When applied to conversation transcripts, the process allows the participants to be identified.

The symbols can be musical notes or midi codes. The sequence of symbols then corresponds to a piece of music, for example in the form of a score or a midi file. The method then makes it possible to detect plagiarism or ghostwriting in musical works.

The symbol sequence may correspond to a gene sequence. The method identifies specialized areas or areas exchanged between different chromosomes and/or different organisms.

In a preferred embodiment, several hundred style parameters corresponding to the occurrence number of different N-grams are calculated for some or all windows. The stylometric distance then depends on a large number of distinct style parameters, making it very difficult for any ghostwriter to attempt to approach the signatory's style.

It has indeed been observed that no specific style parameter, for example no specific N-gram, provides a sufficient marker; only by taking into account a large number, usually greater than 20, preferably greater than 100, of style parameters does it become possible to ensure that each author will be authenticated effectively.

Some style parameters may depend on the average or median distance between two predetermined symbols within the window. For example, the average distance between two full stops, between two commas or between other punctuation symbols, is highly personal.

The discrimination between styles is reinforced by the joint use of different types of stylometric parameters, for example by associating unigrams and bigrams of different types of symbols. One author will be characterized by an unusually frequent use of the letter <g>; another, by the bigrammes <aa> and <ch> for example. Some authors prefer short words in short sentences, others ignore semi-colons, and so on. The use of several types of stylometric parameters makes it possible to ensure that the markers characterizing each author will indeed be taken into consideration.

The window to be authenticated may come from a first author, at least one reference window may correspond to a second author. The method may then include marking the window to be authenticated as a plagiarized window or one produced by ghostwriting.

The method can also be used to identify the author of a window to be authenticated by comparing stylometric parameters with those of several reference windows.

The reference window can come from the same text or symbol sequence as the window to authenticate. The method then makes it possible to detect breaks in style within the same text, which may be an indication of plagiarism or ghostwriting for part of this sequence.

The reference window may be from another text or symbol sequence than the window to be authenticated. The method then makes it possible to detect differences in style between two sequences of symbols, for example between a document authenticated as coming from an author and a document or a portion of document to be verified.

It is possible to compare all the windows to be authenticated to the same reference window, or to a group of windows forming a reference. In the case of the comparison with a reference group, it is possible to compare the windows to be authenticated with the average of the symbol sequence or the average of a set of windows from one or more authors.

The stylometric distance can be a mathematical distance between style parameters made or between sets of style measurements made: for example a Euclidean distance, Manhattan, cos Θ (cosine similarity or cosine measurement), etc. It can be measured between two windows, between a window and a group of windows or between two groups of windows representing all or part of one or more sequences of symbols.

The method may include a step of grouping the windows according to their style settings.

The grouping can be performed by different multivariate statistical treatments. For example, a principal component analysis (PCA), or principal coordinate analysis (PCo, also called MDS MultiDimensional Scaling) working on the mathematical distances defined between observations of the style parameters (eg bigrams) reduces the number of original dimensions (the number of types of bigrams). Such groupings make it possible to detect the most characteristic style parameters of an author.

In one variant, the Euclidean distance is performed without multivariate statistical processing. This approach is more sensitive to noise, since the stylometric distance between two windows takes into account all style parameters, even the least individual ones. On the other hand, it avoids using the most characteristic style parameters with less personal parameters, or neglecting very individual style parameters that yet occur only very rarely.

The size of the windows is advantageously sufficient to allow a meaningful style analysis, but nevertheless small enough to allow the detection of small fragments of plagiarized or ghostwritten sequences. For example, conclusive tests in bigrams analyzes of text have been made with windows containing between 500 and 10,000 symbols.

### BRIEF DESCRIPTION OF THE FIGURES

Examples of implementations of the invention are indicated in the description illustrated by the appended figures in which:

FIG. 1 illustrates by way of example a computer device including in particular some of the components necessary for the implementation of the invention;

FIG. 2 illustrates the memory of the device of FIG. 1;

FIG. 3 illustrates an example of a sequence of symbols, in the present case a document of text type, and of a windowing within this text;

FIG. 4 graphically illustrates different style settings associated with different windows;

FIG. 5 graphically illustrates the stylistic distance between different windows of a symbol sequence and a reference window or set of reference windows.

### EXAMPLE(S) OF EMBODIMENT OF THE INVENTION

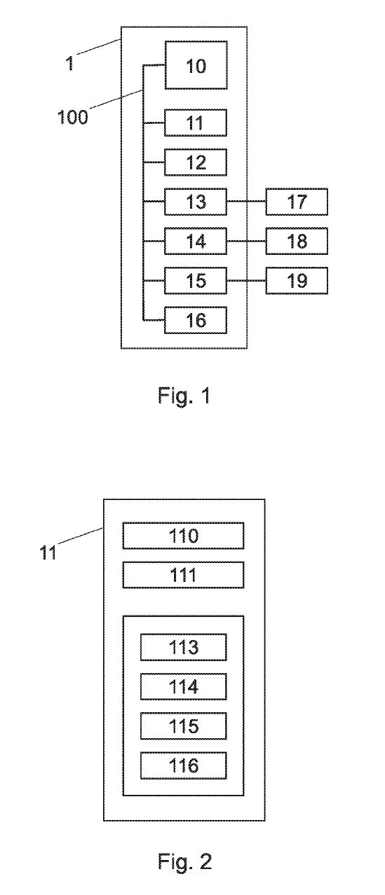

The method for detecting breaks in style described in this application has the particular advantage of being able to be implemented by means of a computer device 1, for example a computer or a server such as that illustrated schematically in FIG. 1. This device comprises notably one or more processors 10, a random access memory 11, a read-only memory 12, a graphics card 13 for controlling a screen 17, an input-output port, for example a USB port 14, allowing the connection of external devices such as scanner 18, printer, etc., a network card 15 for connection to a network 19, for example an Ethernet network, and data input devices such as keyboard, mouse, touch screen, etc.

The memory 11 comprises a portion 110 for the operating system, a portion 111 for the data and a portion 112 for the application programs. This portion 112 comprises in particular a windowing module 113, a stylistic parameter determination module 114, a stylistic distance calculation module 115, and a style break identification module 116. The “modules” above are advantageously constituted by portions of computer code, for example programs, program extracts, routines, procedures, etc., arranged to be executed by the microprocessor 10 in order to execute the windowing operations, for determining stylistic parameters, calculating stylistic distance, and respectively identifying breaks in style which will be described below by way of example. These modules can be stored on a computer medium, for example a cd-rom, a hard disk, a flash memory, etc., before being loaded into the memory 11 as illustrated.

The method makes it possible to detect breaks in style within a sequence of symbols or between two sequences. The symbol sequence may be a document, for example a text-type document. “Break of style” is understood to mean the switch within a sequence or between two sequences from a first style to a second different style, which can reveal for example the switch from a fragment by one author to that by another author. The first step of the method therefore consists in obtaining in electronic copy a first sequence of symbols to be tested and, in the case of a comparison with other sequences, the necessary reference sequences. This sequence of symbols can be loaded for example from the Internet, via e-mail, from a removable data medium etc.

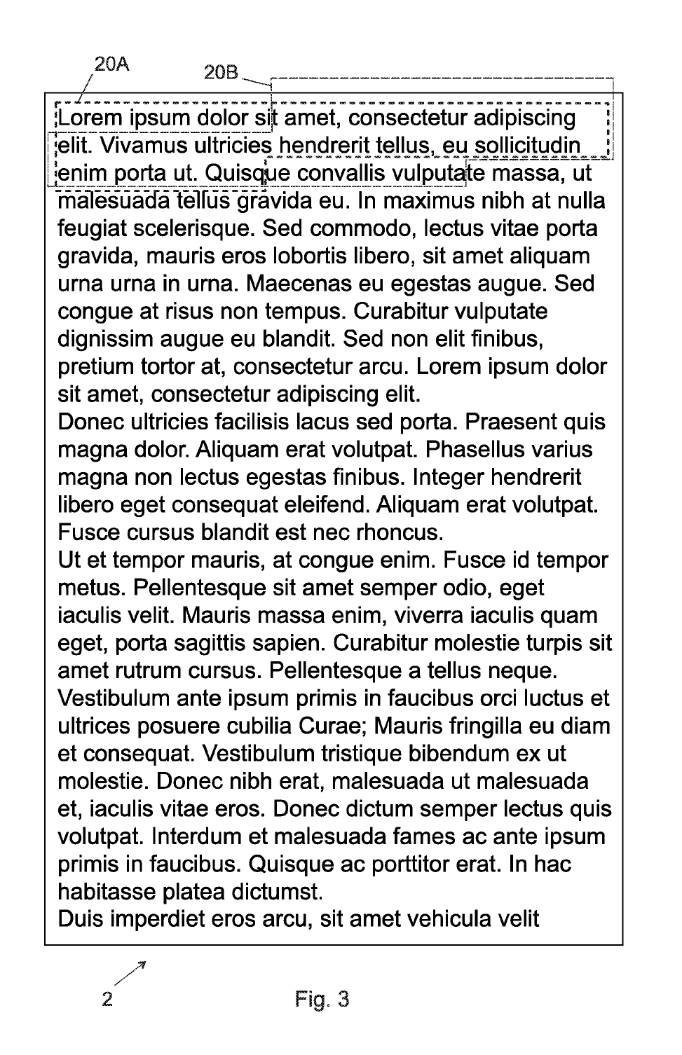

The sequence tested as well as the reference sequences may comprise different types of symbols. In the case of a text, the symbols consist of the letters or other alphanumeric characters of the text. An example of an alphanumeric symbol sequence 2 is illustrated in FIG. 3. In the case of a musical file, for example a musical score, the symbols consist of notes.

The windowing module 113 can, as an option, standardize the sequence, for example by eliminating unnecessary spaces, page numbers, digits, remove graphical accents from accented letters or replace uppercase letters with lowercase letters. The standardisation operations performed depend on the type of symbol sequence. The end user, i.e. the person requesting the authentication of the document, can also choose the type of automatic standardisation to be performed.

The windowing module 113 then slices the optionally standardized symbol sequence into a plurality of windows 20A, 20B, etc. Each window 20 is constituted by a sequence of L consecutive symbols within the complete sequence. The number L of characters in all the windows is preferably fixed, for example here 129, including spaces. In practice, longer window sizes, for example windows with L=at least 500 characters, will preferably be chosen in order to extract meaningful style parameters from each window. The length of the windows can be a parameter chosen by the user during the execution of the program, according to the type of symbol sequences, the calculation power available, the required precision, etc. The window length can also be varied automatically by the program, for example by successively using several shorter and shorter lengths until a plagiarized passage has been detected, and/or according to the a priori probability of having a plagiarism in a given portion of the sequence.

The number of characters in each window is advantageously identical, although it is not an imperative condition; windows containing different numbers of symbols from each other may be used, for example by using small windows in portions of text where the probability of quoting is higher.

Window slicing is advantageously independent of the contents; it is not therefore a division into grammatical or syntactic elements, and it is independent for example of the beginning or the end of sentences, paragraphs or pages. This allows an analysis with window sizes independent of the author's style. It also allows an analysis of punctuation sequences by fixed-length windows.

In one aspect, the windows 20 partially overlap, in the sense that certain symbols, or even most symbols, belong simultaneously to several windows. In the example of FIG. 3, the window 20A comprises the sequence of characters

Lorem ipsum dolor sit amet, consectetur adipiscing elite. Vivamus ultricates hendrerit tellus, solicitudin enim carried ut. Quisq

while the next window 20B comprises the continuation

t amet, consectetur adipiscing elit. Vivamus ultricates hendrerit tellus, solicitudin enim carried ut. Quisque convallis vulputa

With the exception of the first 20 symbols of the window 20A and the last 20 symbols of the window 20B, the two windows 20A and 20B are therefore identical. The window 20B is obtained from the first window 20A and the symbol sequence 2 by a shift of K symbols, here 20. K shift values other than 20 may also be used, provided that K is less than the length L of the windows. The shift value can be a parameter chosen by the user when executing the program, depending on the type of documents, the available computing power, the required accuracy, etc. The shift value can be derived from one or other parameters selected by the user. For example, the user chooses a degree of coverage C, indicating the number of windows to which each symbol must belong simultaneously, and the value of K is calculated accordingly. The shift value can also be varied automatically by the program, for example according to the a priori probability of having a plagiarized or ghostwritten text in a given portion of the sequence.

The module 114 then determines style parameters in each window. The number of style parameters extracted from each window can be considerable; in one embodiment, at least 100 style parameters, preferably at least 500 style parameters, or even thousands of style parameters, are extracted from each window 20.

Style parameters can quantify different types of symbols. To illustrate the different types of possible style parameters, different strategies for graphemic style measurement types are presented below:
Number of occurrences of N-grams predefined in the window—an N-gram consisting of a series of N consecutive symbols—N that can routinely take any integer value between 1 and 5. In a preferred embodiment, the number of occurrences of all the unigrams (uppercase or lowercase characters, punctuation marks) and all possible bigrams (<aa>, <ab>, <ac>, etc.) in each window is counted, as well as the number of occurrences of at least some predefined trigrams, quadrams and pentagrams. The predefined N-grams include words but also sequences of symbols that do not correspond to complete words.
Number of occurrences of predefined character strings in the window, where each sequence may include one or more alternate insert characters (<a * a>, <a * b>, etc.; <a ** a>, <a ** b>, etc., where the insert character * can be any character).
Distribution or particular sequences of punctuation N-grams, an N-gram of punctuation consisting of N punctuation symbols that appear consecutively in a sequence of characters. It is possible to detect and count for example punctuation patterns, for example <full stop; comma; comma; full stop> or <full stop; comma; three full stops>.
Distribution or particular sequences of N-grams of word length. These are routinely bigrams whose elements are the length of two consecutive words. For example, the text “je suis née à Paris” gives the following bigrams: <2.4> <4.3> <3.1> and <1, 5>.
Average length of words, sentences, paragraphs; the average number of characters between each comma, between each semicolon, between each exclamation mark, etc.
Distribution of N-grams of vowels, consonants, phonemes, diphthongs, etc.
Distribution of N-grams of beginning and/or end of word, etc.

It is possible to make a selection of the most relevant style parameters and to retain only the most relevant style parameters depending on the context. For example, style parameters that do not differ significantly from averages observed in similar texts can be eliminated to facilitate distance calculation and make the system less sensitive to pure chance variations.

Different style settings can be grouped to maximize the distance between style settings associated with different authors.

This grouping is optional and a direct comparison of the style parameters in different windows is also possible. It is possible, for example, to count the differences between several tens or hundreds of style parameters within the reference window and the window to be authenticated, and then to deduce a break in style depending on the result of these comparisons. This avoids the calculation of statistical values.

Multivariate statistical processing by Principal Coordinate analysis (PCo), also known as MDS (MultiDimensional Scaling), can be used for grouping the style parameters. This analysis, allowing the use of different types of mathematical distances, reduces the number of dimensions required for representating the variance between the parameters.

Multivariate statistical processing by Principal Component Analysis (PCA) can also be used to do this type of grouping.

Other methods of analysis, including Fisher Linear Discriminant Analysis (LDA), Delta Burrows, Cross Entropy Juola Wyler, WEKA can also be used.

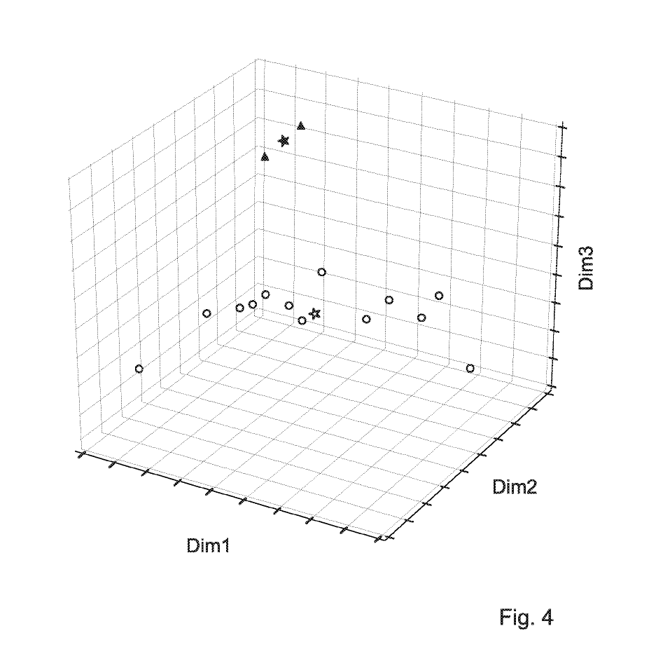

FIG. 4 illustrates the position of different symbol windows of an analysis in a three-dimensional space. Each axis may for example correspond to the frequency of an N-gram; in a variant, each axis corresponds to a dimension obtained after a multivariate analysis, according to the size reduction of a multivariate statistical processing to optimize the variance between windows borne by the style parameters. The circles correspond to windows written by a first author, the two triangles to windows written by a second author; the stars correspond to the average points of the groups of windows corresponding to each of the two authors. It is obvious that the number of dimensions can be much larger than three in the case where more than three distinct style parameters are extracted from each window 20 and that these style parameters are not grouped together.

The stylistic distance calculation module 115 then calculates the stylometric distance between each window 20 and a reference window or group of windows.

The group of reference windows may for example come from another sequence of symbols—for example a sequence whose author is known, or even a reference sequence written by the alleged author of the sequence tested. In another embodiment, the reference window group is from the symbol sequence itself; it can be for example all the windows of this sequence when the process is used to isolate plagiarized passages whose style differs from that of the rest of the document. The method can then consist of a detection of windows whose stylometric distance to the average of the complete sequence exceeds a threshold value determined by practice; these windows are suspected of containing plagiarized or ghostwritten text.

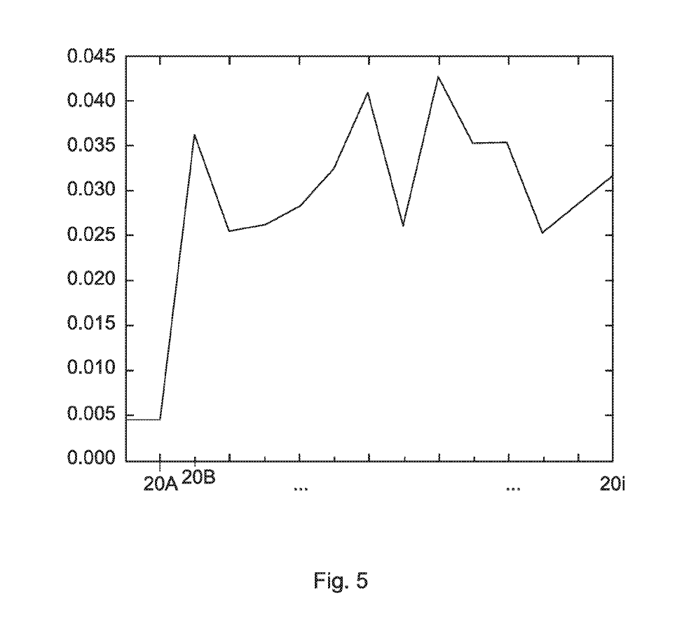

According to an independent aspect of the overlapping slicing, the module 115 determines a vector representative of the reference windows, for example the average point of the reference windows, i.e. the average (centroid or barycentre) of the points representing these windows, or in a multidimensional space (number of dimensions determined by the number of types of style parameters requested by the analysis), or in the reduced-dimensional space obtained by multivariate statistical processing. It then calculates the distance between the point of each window and the average point. FIG. 5 maps the distance to the average point of each window (20A, 20B, 20i) on a curve. The considerable distance jump between the window 20A and the window 20B at the beginning of the sequence shows a break of style between these two windows and is an indication of a change of author.

The mathematical stylometric distance between points can be a Euclidean distance, a Manhattan distance, or a cos Θ distance for example.

In calculating the stylometric distance, a point can represent a window or the average point of a group of windows.

The module 116 identifies suspicious test windows, i.e. those whose distance to the average point of the reference windows varies from previous or subsequent windows, or exceeds a threshold defined by practice on the stylometric analysis of one or more authors. Suspicious windows can be marked in the symbol sequence or retrieved to allow verification by a human operator. An index of probability of change of rupture can be displayed. A distance curve between the point of each test window and the average points of groups of reference windows can also be displayed.

In one embodiment, the contents of these suspect test windows are transmitted to another non-illustrated computer module to confirm the suspicion of plagiarism or ghostwriting, or to rule out any suspicion of fraud. This other module can, among other things, search for a suspicious text in a database, for example a database of reference texts or an Internet search engine, in order to check the presence of fragments of these windows in an earlier work.

1. Method for detecting style breaks within one or more symbol sequences, comprising the following steps:
automatically slicing at least one said symbol sequence into a plurality of windows, with at least two windows overlapping;
determining a plurality of style parameters in some or all of said windows, at least one said style parameter corresponding to the number of occurrences of at least two predetermined N-grams in the window, each said N-gram consisting of a sequence N predetermined symbols, N being less than or equal to 5;
calculating by a processor a stylometric distance between at least one said window to be authenticated and a reference window or a group of reference windows, the stylometric distance between two windows or groups of windows depending on several style parameters;
identifying windows to authenticate based on their stylometric distance relative to the reference window or group of reference windows.

2. Method according to claim 1, said symbols being alphanumeric characters, said symbol sequence being a text.

3. Method according to claim 1, said symbols being phonemes, said symbol sequence corresponding to a sequence of phonemes.

4. Method according to claim 1, said symbols being notes or midi codes, said symbol sequence corresponding to a piece of music.

5. Method according to claim 1, wherein the window to be authenticated comes from a first author, at least one said reference window corresponding to a second author, the identification comprising the marking of the window to be authenticated as a window plagiarized or produced by ghostwriting.

6. Method according to claim 1, wherein more than one hundred style parameters corresponding to the number of occurrences of different N-grams are calculated for some or all of said windows.

7. Method according to claim 1, wherein at least one said style parameter depends on sequences of punctuation marks.

8. Method according to claim 1, wherein at least one said style parameter depends on the number of occurrences or on the average or median distance between two predetermined punctuation marks within said window.

9. Method according to claim 1, wherein at least one said style parameter depends on sequences of word lengths.

10. Method according to claim 1, said stylometric distance being a mathematical distance between points representing the windows defined by as many dimensions as types of style parameters or by a number of dimensions reduced by multivariate statistical processing.

11. Method according to claim 1, comprising a step of calculating a vector representative of the reference windows, and then calculating a stylometric distance between at least one said window to be authenticated and said representative vector.

12. Method according to claim 1, comprising a step of grouping windows, said stylometric distance depending on the distance between the average points of the groups of corresponding points.

13. Method according to claim 1, with each said window comprising more than 500 symbols.

14. Computer data carrier comprising a computer program for execution by a processor for executing the method of claim 1.

15. Device for detecting style breaks within one or more symbol sequences, comprising:
a module for automatically slicing at least one said symbol sequence into a plurality of windows, with at least two windows partially overlapping;
a module for determining a plurality of style parameters in some or all of said windows, at least one said style parameter corresponding to the number of occurrences of at least two predetermined N-grams in the window, each N-gram consisting of a sequence of N predetermined symbols, N being less than or equal to 5;
a module for calculating a stylometric distance between at least one said window to be authenticated and one or more reference windows, the stylometric distance between two windows or groups of windows depending on several style parameters;
a module for identifying the windows to be authenticated for which the stylometric distance with respect to the reference window or windows is greater than a predetermined threshold.
